(19) United States
(12) Patent Application Publication
(10) Pub. No.: US 2023/0020245 A1
(43) Pub. Date: Jan. 19, 2023

(54) APPARATUS, METHODS, AND SYSTEM FOR SAFEKEEPING BUILDING PERMITS AND OTHER DOCUMENTS FOR REMOVABLY ATTACHING TO A LADDER

(71) Applicant: Eugene Petilli, Lighthouse Point, FL (US)

(72) Inventor: Eugene Petilli, Lighthouse Point, FL (US)

(21) Appl. No.: 17/860,956

(22) Filed: Jul. 8, 2022

Related U.S. Application Data
(60) Provisional application No. 63/219,368, filed on Jul. 8, 2021.

(51) Int. Cl. E06C 1/383

(52) U.S. Cl. CPC E06C 1/383

(57) ABSTRACT

A system for safekeeping of building permits and other documents is disclosed. The system comprises a ladder comprising a plurality of rungs spaced apart and extending through a stringer of the ladder. Each rung of the plurality of rungs has a channel, wherein the channel has opening on the stringer. The system further comprises a device comprising a container, a first arm having a first arm first end and a first arm second end, a second arm having a second arm first end and a second arm second end. Each of the first arm and the second arm are in attachment with a side of the container. The system further comprises an assembled configuration wherein the opening of a first rung of the plurality of rungs receives the first arm second end and the opening of a second rung adjacent to the first rung receives a second arm second end.

### CROSS-REFERENCE TO RELATED APPLICATIONS

This application claims the benefit of the filing date of U.S. Provisional Application Ser. No. 63/219,368 titled “SYSTEM FOR SAFEKEEPING OF BUILDING PERMITS AND OTHER DOCUMENTS REMOVABLY ATTACHED TO A LADDER HAVING A PLURALITY OF RUNGS” and filed Jul. 8, 2021, and the subject matter of which is incorporated herein by reference.

### STATEMENT REGARDING FEDERALLY SPONSORED RESEARCH OR DEVELOPMENT

Not applicable.

### INCORPORATION BY REFERENCE OF MATERIAL SUBMITTED ON A COMPACT DISC

Not applicable.

### TECHNICAL FIELD

The present disclosure relates to the field of containers, and more specifically to the field of containers for use on ladders.

### BACKGROUND

Contractors, builders, roofers, inspectors, and other professionals must store a combination of various documentation, including building and construction project permits, on job sites for inspections. The storage of such documents is necessary to successfully evaluate the status of the projects and to comply with standard business practice and local ordinances.

Permit documents are generally stored in document boxes that are permanently affixed on the project premises. For building and inspections, the codes, plans, and permit documents are removed from the document boxes to execute to building plans and adequately inspect the project. The documents are loose and are usually carried around while the building and inspection occurs. As a result, permits and other documents may be lost or damaged. Additionally, when construction and inspection require the use of a ladder, there is a significant safety hazard associated with holding various items trying to write while balancing on a ladder. The haphazard way one must simultaneously secure themselves to the ladder, view building permits, and write notes is a safety concern on the job site and poses increased dangers as documents and tools may be dropped from the ladder if not safely secured.

Furthermore, building documents, such as building permits, are extremely important documents that are necessary for many construction projects. As a result, it is paramount to store the building permit in a safe, secure place on a job site or while in transit between job sites. Storing the building permit in a secure, opaque container makes it difficult to see or view the building permit within the container on the job site. If one removes the building permit from the opaque container to view the document, then one exposes the building permit to the elements and hazards on a job site. Storing the building permit in a non-opaque container can help facilitate viewing the building permit within the container, but that still does not resolve the issue of a professional, such as a roofer, balancing themselves on the ladder while attempting to view the building permit and do other work, such as write notes or use a tool.

In addition, professionals, such as roofers, frequently write notes while on ladders and inspecting building structures and building permits. In certain instances, the roofer must draft these notes while on the ladder. Trying to write notes without a stable surface leads to errant writing with poor penmanship. Trying to write against a surface, such as the ladder itself, leads to crumpled papers and poor penmanship. Utilizing a writing surface, such as a clipboard, to provide a stable writing surface just adds an additional item that the roofer must balance while on a ladder, simply increasing the risk of an accident. Ladders that contain a flat surface at the top of the ladder may provide a writing surface, but this surface is typically at a fixed point. Having a fixed point for a writing surface greatly reduces the flexibility and usability of the ladder, and frequently this feature is only on shorter ladders, which may not have sufficient height for roofing projects.

Building professionals must multitask while on a job site and rely upon a mix of various devices to accomplish all necessary tasks. However, using a plurality of devices to complete all the tasks increases the risk of accident while in a ladder on a job site.

As a result, there exists a need for improvements over the prior art and more particularly for a more efficient way of containing and securing building permits and other items to a ladder.

### SUMMARY

A system and method for safekeeping of building permits and other documents is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a system for safekeeping of building permits and other documents is disclosed. The system comprises a ladder comprising a plurality of rungs spaced apart and extending through a stringer of the ladder. Each rung of the plurality of rungs has a channel, wherein the channel has opening on the stringer. The system further comprises a device comprising a container, a first arm having a first arm first end and a first arm second end, a second arm having a second arm first end and a second arm second end. Each of the first arm and the second arm are in attachment with a side of the container. In one embodiment, each of the first arm and second arm are independently hingedly attached to the side of the container by a hinge and/or hinge-like system having a rotatable element allowing each arm to extend perpendicular to the side of the container. The arms may be directly attached to, affixed, and/or removably fastened to the side of the container directly or indirectly. The system further comprises an assembled configuration wherein the opening of a first rung of the plurality of rungs receives the first arm second end and the opening of a second rung adjacent to the first rung receives a second arm second end. The assembled configuration is defined by the container being disposed proximate to the stringer of the ladder and configured for operational use.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the disclosure and together with the description, explain the principles of the disclosed embodiments. The embodiments illustrated herein are presently preferred, it being understood, however, that the disclosure is not limited to the precise arrangements and instrumentalities shown, wherein:

FIG. 1A is a perspective view of a device for safekeeping of building permits and other documents, according to an example embodiment.

FIG. 1B is a side view of the device for safekeeping of building permits and other documents, according to an example embodiment.

FIG. 1C is a back perspective view of the device for safekeeping of building permits and other documents, according to an example embodiment.

FIGS. 2A and 2B are perspective views of the device for safekeeping of building permits and other documents, according to an example embodiment.

FIG. 3 is a perspective view of a lid of the device, according to an example embodiment.

FIG. 4 is a perspective view of the container of the device, according to an example embodiment.

FIG. 5 is a front view of the system for safekeeping of building permits and other documents, according to an example embodiment.

FIG. 6 is a perspective view of the system for safekeeping of building permits and other documents, according to an example embodiment.

FIG. 7 is a perspective view of the device for safekeeping of building permits and other documents, according to an example embodiment.

FIG. 8 is a perspective view of the device for safekeeping of building permits and other documents, according to an example embodiment.

FIG. 9 is a side view of the device for safekeeping of building permits and other documents, according to an example embodiment.

FIG. 10 is a front view of the device for safekeeping of building permits and other documents, according to an example embodiment.

FIG. 11 is a back perspective view of the device for safekeeping of building permits and other documents, according to an example embodiment.

FIG. 12 is a side view of the lid, according to an example embodiment.

FIGS. 13A and 13B are side views of an arm, according to an example embodiment.

Like reference numerals refer to like parts throughout the various views of the drawings. The figures are drawn to scale.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions, or modifications may be made to the elements illustrated in the drawings, and the methods described herein may be modified by substituting reordering or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems with the prior art by providing a system for safekeeping of building permits and other documents removably attached to a ladder having a plurality of rungs. The system improves over the prior art by providing a sealable and waterproof container and including a first arm and a second arm each having a first end and a second end. The first arm and the second arm are in attachment with a side of the container at a distance apart. The system improves over the prior art because each of the first arm and second arm can be received by an opening on a ladder where the system can be secured to the ladder. The system provides a secured container for storing documents to a ladder and, in one example embodiment, improves upon the prior art by providing a surface of the container parallel to the stringer of the ladder such that the surface is configured for writing on documents while standing on the ladder. In one embodiment, a latch is hingedly attached to the writing surface configured to hold documents. In another embodiment, the writing surface is hingedly attached to the interior of the container such that the writing surface is a clipboard configured for writing on while the user is standing on the ladder and the clipboard is further configured to fold into the interior of the container during nonuse. In an additional embodiment, a holder for a writing utensil, such as a pen, is included within the writing surface. Moreover, in other embodiments, the system improves upon the prior art by having a collapsible first arm and second arm to store the system when it is not attached to the ladder.

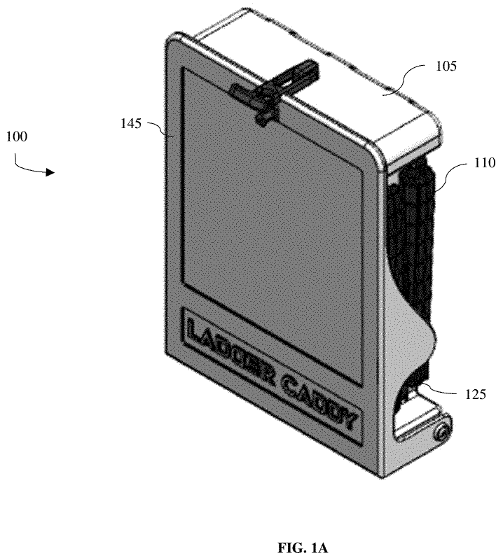

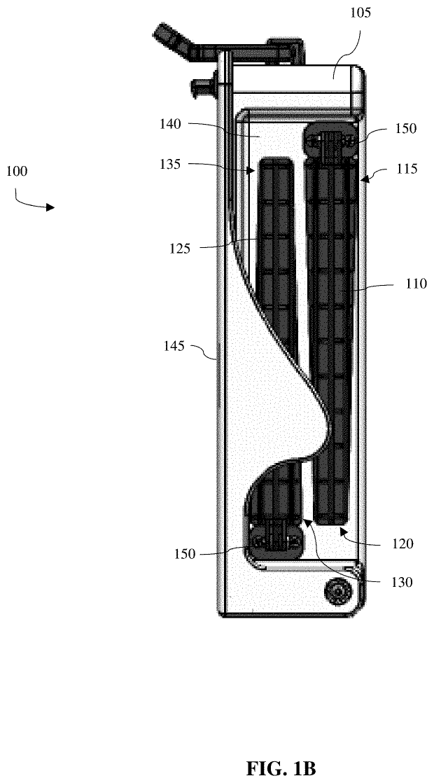

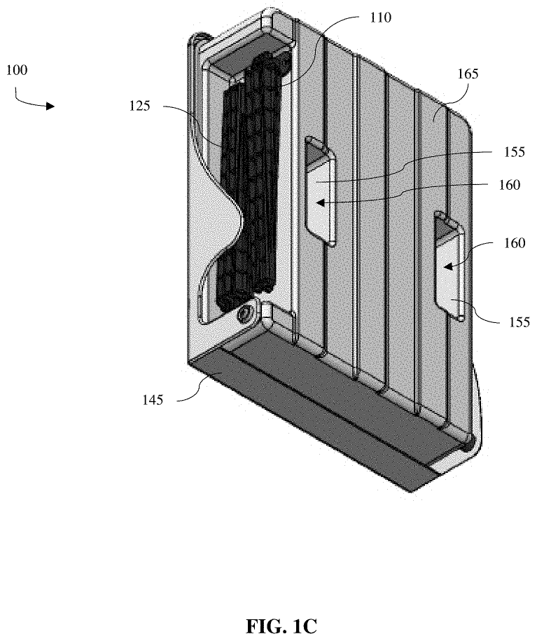

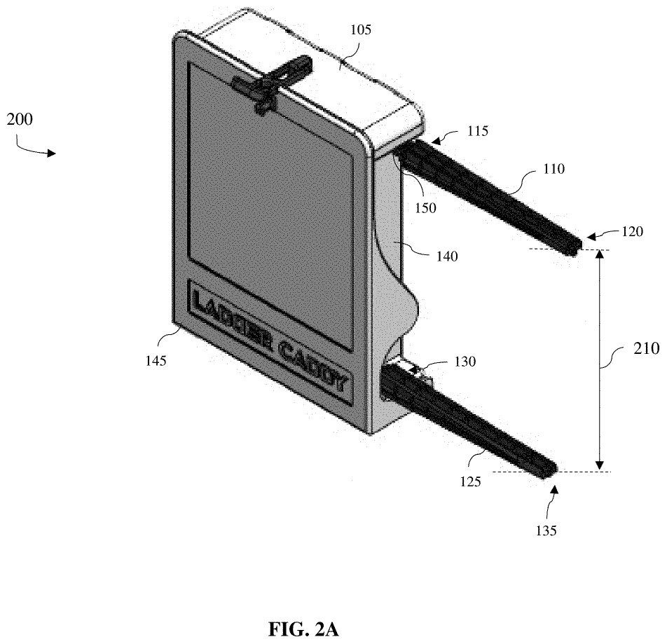

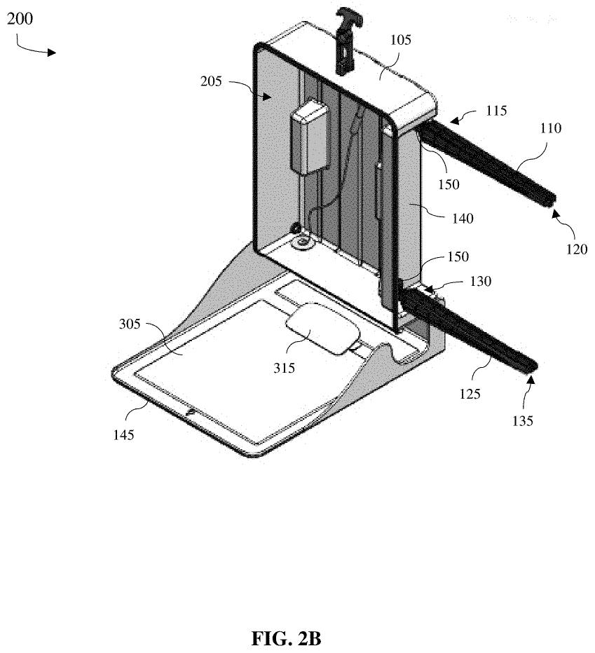

Referring now to the Figures, FIGS. 1A-1C illustrate views of a device 100 for safekeeping of building permits and other documents, according to an example embodiment. The device is configured for removably attaching to a ladder having a plurality of rungs such that a user of the device may install the device at any height of the ladder. The device includes a container 105, a first arm 110 having a first arm first end 115 and a first arm second end 120, and a second arm 125 having a second arm first end 130 and a second arm second end 135. The first arm first end and the second arm first end are each movably in attachment with a side 140 of the container. The distance is configured to correspond with the distance between adjacent rungs of the ladder. In one embodiment, the first arm and second arm are attached to the container where the first arm and second arm are permanently affixed to the side of the container. In an additional embodiment, the first arm and second arm are attached to the container where the first arm and second arm are removably affixed to the side of the container. Please note that the side of the container is defined as the side of the container where the first arm and second arm attach to the container. The device also includes a lid 145 configured to enclose an opening (205 in FIG. 2B) on the container.

The container can have a rectangular shape, depicted in an example embodiment. The container may be comprised of material such as carbon steel, stainless steel, aluminum, titanium, other metals or alloys, composites, ceramics, polymeric materials such as polycarbonates, such as Acrylonitrile butadiene styrene (ABS plastic), Lexan™, and Makrolon™. The container may be formed from a single piece or from several individual pieces joined or coupled together. The components of the container may be manufactured from a variety of different processes including an extrusion process, a mold, welding, shearing, punching welding, folding etc. The device further includes at least one handle 155 defined by a recessed portion 160 on a back side 165 of the container, shown in FIG. 1C. The recessed portion protrudes towards the interior of the container such that the handle does not protrude outside of the container to increase the device's size. The recessed portion receives the fingers of the user to allow the user to grasp the device. In some embodiments, the handle may be a u-shaped handle that extends outwards from the back side of the container. In other embodiments, other types of handles configured to provide the user with easier handling of the device may be used and are within the spirit and scope of the present invention.

The first arm and the second arm may include materials such as carbon steel, stainless steel, aluminum, titanium, other metals or alloys, composites, ceramics, polymeric materials such as polycarbonates, such as Acrylonitrile butadiene styrene (ABS plastic), Lexan™, and Makrolon™. The first arm and the second arm may be formed from a single piece or from several individual pieces joined or coupled together. The components of the first arm and the second arm may be manufactured from a variety of different processes including an extrusion process, a mold, welding, shearing, punching welding, folding etc. To affix the arms to the side of the container, attachment devices 150 such as a pressure grip clamp, pressure grip clamp bolt, suction cup, hooks, bolt, set crews, opening configured to attached to protruding element, socket screws U-bolts, twine, etc. may be utilized. In addition, the attachment device may be an adhesive substance, such as a pressure sensitive adhesive comprising materials such as comprise lanolin, mineral oil, petrolatum, rosin, silicone, and zinc oxide. The backing may be made of material, such as wax paper or other materials used to protect adhesive materials. However, other types of attachment devices may also be used and are within the spirit and scope of the present invention. The attachment devices may be manufactured from a variety of different processes including an extrusion process, a mold, welding, shearing, punching welding, folding etc.

The device 100 further includes a stowed configuration (shown in FIGS. 1A and 1B) in which the first arm second end and second arm second end are disposed proximate to, at, close to, and/or near the side of the container. In the stowed configuration, the first arm and second arm are not extended and are folded to be positioned against the side of the container. Additionally, the device is compact to allow for convenient portability such that the user may carry the device when not installed on the ladder. The stowed configuration also allows for more efficient storage because the device takes up less space due to its compactness.

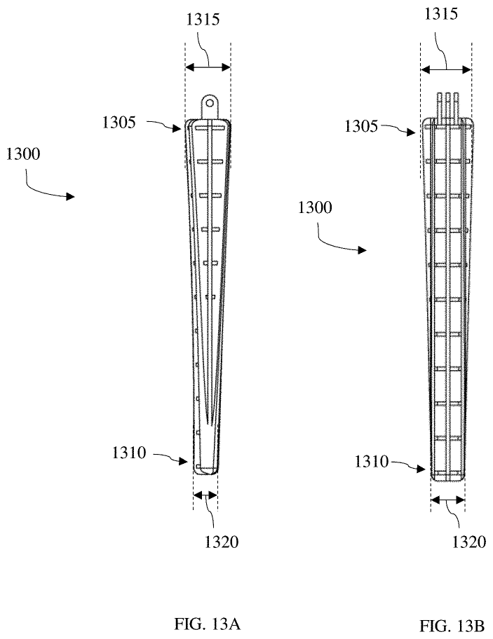

Referring now to FIGS. 2A-2B and 13A-13B, perspective views of a device 200 in an extended configuration are illustrated, according to an example embodiment. In the extended configuration, the first arm 110 and the second arm 125 are each disposed substantially perpendicular to the side of the container such that the first arm second end and second arm second end are away from the side of the container. The extended configuration allows the first arm and the second arm to be assembled onto the ladder. Additionally, the first arm and second arm are spaced apart at a distance 210. In some embodiments, in the extended configuration, the distance 210 may be adjusted according to the distance between adjacent rungs of the ladder. For example, at least one of the first arm first end and the second arm second end may be in attachment with a track to provide adjustability of the distance 210 to align the first arm and second arm to respective rungs.

FIGS. 13A and 13B show an example embodiment of an arm 1300, which represents the first arm and second. The first arm and the second arm are tapered from its respective first end 1305 to its respective second end 1310 such that that the first end includes a first cross section having a first diameter 1315 greater than a second diameter 1320 of a second cross section of the second end. The tapering of the first arm and second arm reduces the thickness of the arms towards the respective second ends, which are narrower than the respective first ends. The first arm and second arm have a narrowing shape due to the tapering. The second diameter is also less than a rung diameter of an opening of a channel of a rung of a ladder. The diameter of the second end of the arm cannot exceed the diameter of the opening of the channel of the rung because the arm would not be able to be inserted into the rung of the ladder. The opening is on the stringer of the ladder. Because the arms become narrower towards the respective second ends, adjacent rungs of the ladder may receive an arm. For example, the first arm second end may be inserted through an opening of a first rung and installed into a channel of the first rung. The second arm second end may be inserted into an opening of the second rung and installed into a channel of the second rung. Generally, the first rung and second rung are adjacent to each other. The first arm first end and the second arm first end will be wedged into the openings of respective rungs because the first diameter is greater than the diameter of the respective openings, thereby holding the device in place on the stringer of the ladder. In other embodiments, the first arm and second arm may be telescopic consisting of concentric tubular sections designed to slide into one another where at least one of the tubular sections has a diameter less than the diameter of the opening of the rungs. This also achieves the narrowing shape allowing the arms to be wedged into the openings of the rungs.

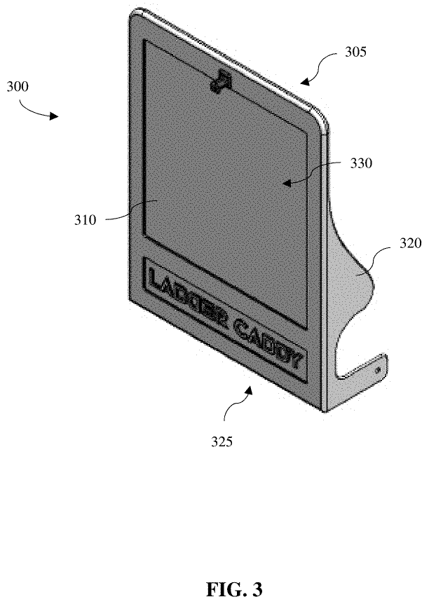

Referring now to FIG. 3, a perspective view of the lid 300 (145 in FIGS. 1A-2B) is shown, according to an example embodiment. The container further includes a lid having a lid first surface 305 that faces the inside of the container and a lid second surface 310 that faces away from the container when the lid is in a closed position. The lid is hingedly attached to a bottom portion 325 of the container. Hingedly means that the lid may rotate in two opposite directions about the part that is in attachment the container. A clip (315 in FIG. 2B) is attached to the lid first surface proximate to the bottom portion of the container. The lid first surface acts as a writing surface on which the user may write on paper. The clip is configured to hold a portion of the paper such that the paper is immobile when written on. The lid can extend outward via various mechanisms, either removably attached or permanently attached, including a hinge, a telescoping action, a removable clip attachment, or fasteners. The types of fasteners can include a pressure grip clamp, pressure grip clamp bolt, suction cup, hooks, bolt, set crews, opening configured to attached to protruding element, socket screws U-bolts, twine, etc. The lid includes at least one side wall 320 proximate to the side (140 in FIG. 2B) of the container.

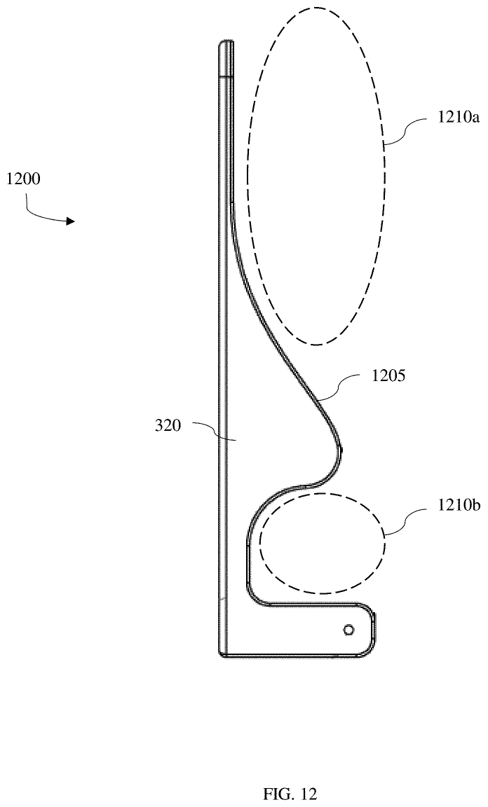

The device also includes a stowed configuration, in which the at least one side wall at least partially covers a portion of at least one of the first arm and the second arm. In the extended configuration of the device, the at least one side wall comprises at least one cutout (1210a and 1210b in FIG. 12) configured to at least partially surround at least one the first arm and the second arm. The cutouts 1210a and 1210b are configured to be disposed around the first arm and second arm, respectively, in the extended configuration. FIG. 13 further illustrates a side view of the lid 300. As shown in FIG. 13, the at least one side wall defines a serpentine shaped edge 1205 such that the lid may open and close when the container is in the extended configuration. The serpentine shaped edge allows the side wall to avoid the first arm and second arm, so the lid may fully enclose the opening (205 in FIG. 2B) in the container. The serpentine shaped edge configures the side wall to be around the first arm and second arm such that the extended first arm and extended second arm do not prohibit the lid from closing. The serpentine shaped edge is curved having the apex of the curve disposed between the first arm and the second arm (in the extended configuration). The curve or wave-like edge has the apex offset from the center of the side proximate to the bottom side of the container. This allows the lid to smoothly open without contacting the arm in the extended configuration. For example, if the side of the lid was defined by a rectangular side with cutouts, then the side would need to be specifically dimensioned and configured to allow for a clearance between the side of the lid and the arms. Therefore, the ideal embodiment it the serpentine shaped edge. However, in other embodiments, the side wall may define edges of other shapes, such as rectangles, configured to allow the lid to close.

The device also includes an open configuration, shown in FIG. 2B, in which the lid first surface and lid second surface are not parallel with the back side of the container. The open configuration provides access to the space within the container for the user to retrieve contents from within the container or to input additional items inside the container. The lid is supported by the hinges or pins that are in attachment with the bottom portion of the container. The clip 315 is disposed on the inside upside-down and proximate to the bottom portion of the container in the closed configuration. The clip is disposed upside-down because, in the open configuration, the user can write on the interior surface of the lid and use the clip to hold paper (as if the clip is right side up). In the open configuration, the lid is substantially perpendicular to the stringer of the ladder to provide a writing surface for the worker on the ladder.

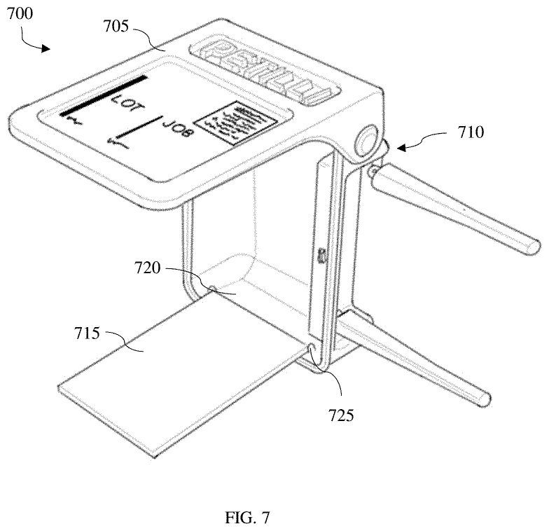

In some embodiments, the lid may be hingedly attached to a top portion of the container, as illustrated in FIGS. 7-11. The hinges for the lid may be detachable or removable in embodiment; in another embodiment, the hinges are non-removable. In one embodiment, a seal is located between the hingedly attached lid and an opening within the container to make the container waterproof and airtight. In an additional embodiment, the seal contains at least one outer edge to receive the lid and at least one inner edge to receive at least one edge of the container that join together to seal the interior of the container from outside particles and debris, including but not limited to water, dust, air, and dirt; the result is a waterproof and airtight interior for storing documents. In an additional embodiment, the seal is removably attached to the container and to the lid. In an additional embodiment the seal is permanently affixed to the container and to the lid. The seal may be constructed of rubber, siloxane, silane, silicone rubber, silicone, neoprene, neoprene rubber, urethane, urethane rubber, platinum cured silicone, foam tapes, sponge foam, tapes, and ethylene propylene diene monomer. Other watertight and airtight seals may be included and are within the spirt and scope of the disclosure.

In one embodiment, an edge of the seal is configured for receiving the container and the container is configured for interlocking with the seal to form the waterproof and airtight configuration. A different embodiment discloses that an edge of the seal is configured for receiving the lid and the lid is configured for interlocking with the seal to form the waterproof and airtight configuration. In one embodiment, an adhesive joins the seal to the container; in an additional embodiment, the adhesive joins the seal to the lid. The adhesive may be a pressure sensitive adhesive comprising materials such as comprise lanolin, mineral oil, petrolatum, rosin, silicone, and zinc oxide. The backing may be made of material, such as wax paper or other materials used to protect adhesive materials. In an additional embodiment, a plurality of tracks affixes the seal to the container; in additional embodiment, a plurality of tracks affixes the seal to the lid. Furthermore, in an additional embodiment, a plurality of snaps affixes the seal to the lid; in an additional embodiment, a plurality of snaps affixes the seal to the container.

In some embodiment, as shown in FIGS. 7-11, the lid further includes a translucent window. The translucent window allows the user to view the contents within the container, such as building permits, documents, or other items, while the container is in the closed configuration. The translucent window material may be comprised of many materials and/or combination of materials including any type of plastic and glass. When the lid is closed as illustrated in FIG. 2A, the lid second surface 310 can define a writing surface. In an example embodiment, the lid second surface may contain a flat portion 330 such that the user may write on the surface of the container. In another example embodiment, the second face may be any face that is parallel to the stringer of the ladder such that the user can write on the surface of the container while standing on the ladder, for example, the side of the container, when the system is attached to the stringer of the ladder using the pressure grip clamps.

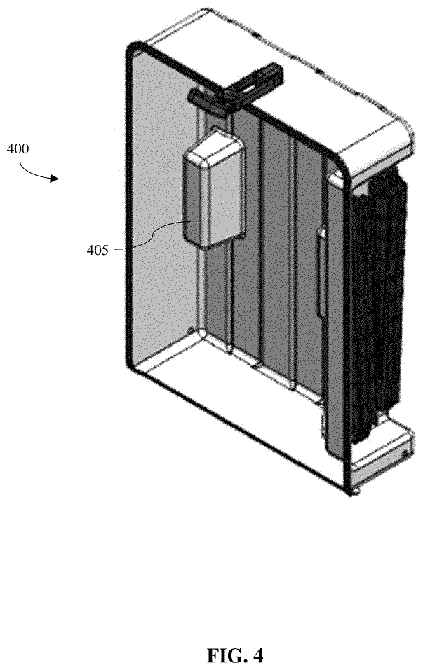

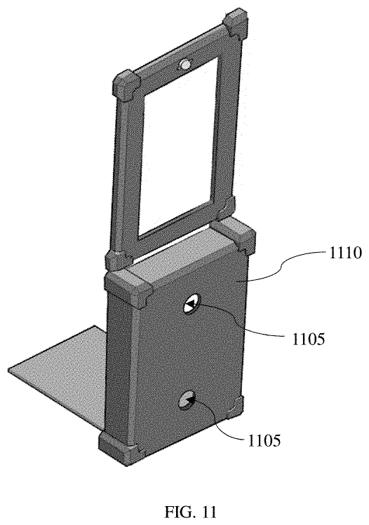

With reference to FIG. 4 and FIG. 11, perspective views of the device are shown, according to an example embodiment. The device 400 further includes a handle 405. The handle is defined by a recessed portion on a back side 1110 of the container. The handle allows the user to hold the device by placing their fingers into the recess portion. The user will usually use the handle to hold the device in the stowed configuration because the device will not be in attachment with the ladder. However, the handle may also be used to hold the device in the extended configuration when the user is installing the device onto the ladder. Because the handle is not protruding outwards from the back side of the device, the device is more compact. However, in some embodiments, the handle may be protruding outwards from the back side. In another embodiment, shown in FIG. 11, the back side 1110 of the container may include at least one opening 1105 in which an attachment device can pass through to secure the system to a surface. Also, in another embodiment, the attachment device can secure the container to any object which is parallel to the rear of the container. The attachment device may be a pressure grip clamp, pressure grip clamp bolt, suction cup, hooks, bolt, set crews, opening configured to attached to protruding element, socket screws U-bolts, twine, etc. In addition, the attachment device may be an adhesive substance, such as a pressure sensitive adhesive comprising materials such as comprise lanolin, mineral oil, petrolatum, rosin, silicone, and zinc oxide. The backing may be made of material, such as wax paper or other materials used to protect adhesive materials. However, other types of attachment devices may also be used and are within the spirit and scope of the present invention.

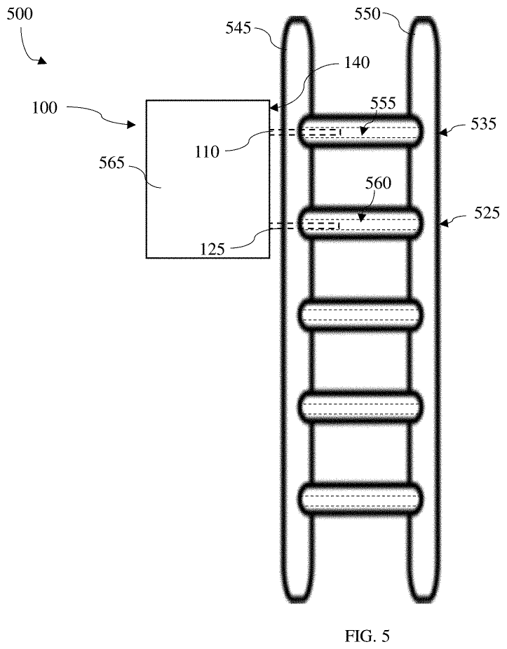

Referring now to FIG. 5, a front view of a system 500 for safekeeping of building permits and other documents is illustrated, according to an example embodiment. The system includes a ladder having a plurality of rungs that are spaced apart and extend through a stringer of the ladder. Each rung of the plurality of rungs has a channel, which has an opening on the stringer. The system further includes the device in an extended configuration and an assembled configuration. In the assembled configuration, the device is in the extended configuration such that the first arm and second arm are perpendicular to the side of the container. Additionally in the assembled configuration, the opening of a first rung of the plurality of rungs receives the first arm second end and the opening of a second rung adjacent to the first rung receives a second arm second end. In one embodiment of the system 100, the container 105 is attached to a ladder. One embodiment has the first arm 110 and the second arm 125 removably attached to the side 140 of the container. In an additional embodiment, the first arm and the second arm are permanently attached to the side of the container. The stored configuration may include the writing surface contained within the container.

A first stringer 545 and a second stringer 550 contain a first opening 535 and a second opening 525 which can be configured for receiving the first arm and the second arm, respectively. In one embodiment, between the first stringer and second stringer, there is a first channel 555 and a second channel 560. In an additional embodiment, the first channel and the second channel are within the first stringer. In a different embodiment, the first channel and the second channel are within the second stringer. In one embodiment, the first opening and the second opening can be disposed on a stringer of the ladder such as including the first channel of a first rung and the second channel of a second rung, respectively. In another embodiment, the first opening and second opening can be the void space between the first ring and second rung such that the first arm and second arm may be inserted within the portion between the first rung and the second rung. In an additional embodiment, the first arm passes through the first opening within the first channel and the second arm passes through the second opening within the second channel to secure the container to the ladder.

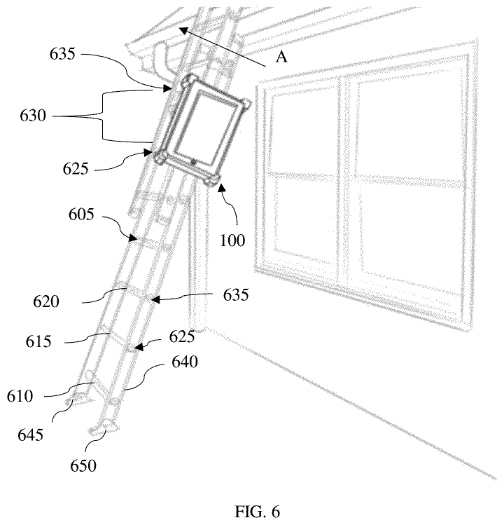

Referring now to FIG. 6, a perspective view of the system 600 for safekeeping of building permits and other documents is illustrated, according to an example embodiment. The ladder includes a plurality of rungs 605 that run between the stringers (345 and 350) of the ladder. The plurality of rungs may contain rungs 610, 615, and 620 for example. Each of rungs 610, 615, and 620 may define the first rung and second rung. The ladder also has a first opening 635 and a second opening 625. In one embodiment, the first opening and the second opening can be disposed on a stringer of the ladder such as including the first channel 660 of the first rung and the second channel 655 of the second rung, respectively. In another embodiment, the first opening and second opening can be the void space between the first ring and second rung such that the first arm and second arm may be inserted within the portion between the first rung and the second rung.

Additionally, the first opening is at a first side end of a first rung of the plurality of rungs and the second opening is at a second side end of a second rung of the plurality of rungs. Each stringer (645 and 650) may define a first side end of the first rung and a second side end of the second rung where the first opening and the second opening are disposed on the stringer such that the first opening and the second opening have a first channel and a second channel configured to receive the first arm and second arm of the system, respectively. In this view, the system 600 is shown in which the first rung and second rung are adjacent. Furthermore, the system has the first arm that extends through a first channel of the first rung and the second arm extends through a second channel of the second rung. A second distance 630 is between the first opening and the second opening. Within this view, the first distance equals the second distance between the first rung and second rung. In an additional embodiment, the first arm and second arm are attached to the container such that the first distance between the first arm first end and second arm first end is adjustable to correspond to the second distance between the first rung and the second rung. For example, the first distance can adjust if the second distance is between adjacent rungs (610 and 615) or can adjust if the second distance is between non-adjacent rungs (610 and 620). In an additional embodiment, FIG. 6 depicts a different embodiment than disclosed in FIG. 1 because the device 100 is in attachment to a side of the stringer of the ladder, and the first arm and second arm are in a horizontally extended configuration, as the container is secured to the first opening and the second opening via attachment to a second face of the container.

As illustrated in FIG. 6, the device 100 of FIG. 1 is attached to the ladder 640 such that the first arm and the second arm are inserted into the channels of the respective rungs of the ladder in the assembled configuration, according to an example embodiment. When in the assembled configuration on the ladder, the writing surface is parallel to the stringer of the ladder such that that second face is oriented in direction A. The plane of the writing runs parallel with the orientation of the ladder such that writing surface appears in the upward facing direction A at a user while on the ladder.

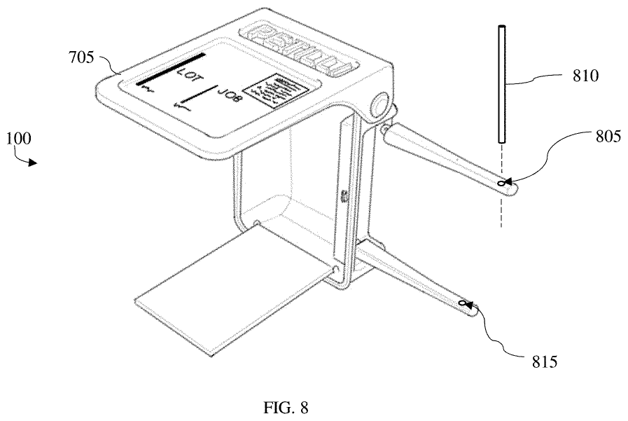

Referring now to FIGS. 7 and 8, perspective views of the device 700 for safekeeping of building permits and other documents is illustrated, according to an example embodiment. The lid 705 is moveably attached to a top portion 710 of the container, while the writing surface 715 is in attachment with an interior wall 720 of the container. In one embodiment, the writing surface may be defined by a clipboard having a latch hingedly attached to the writing surface for securing items, such as documents, to the writing surface. In one embodiment, the writing surface is a clipboard hingedly attached to the interior of the container. In one embodiment, the writing surface contains a holder for a writing utensil, such as a pen. In the assembled configuration, the writing surface may be parallel to a rung of the ladder such that the rung defines a standing surface configured for supporting a user on the ladder. Therefore, the writing surface may be parallel to the standing surface. In an additional embodiment, the writing surface may be perpendicular to a stringer of the ladder in the assembled configuration. To hingedly attach the writing surface to the interior of the container and the latch to the writing surface, the system may include barrel hinges, piano hinges, butterfly hinges, pivot hinges, living hinges, spring hinges, butt hinges, pivot hinges, and gate hinges. Other hinges are within the spirit and scope of the disclosure. At least one fastener 725 affixes the latch to the writing surface and the writing surface to the interior of the container. The fastener may include a suction cup, hooks, bolt, set crews, opening configured to attached to a protruding element, socket screws u-bolts, twine, etc. However, other types of fasteners may also be used and are within the spirit and scope of the present invention.

Furthermore, the system includes a first hole that extends through the first arm and a second hole that extends through the second arm. Within the view shown in FIG. 8, the first arm and the second arm are in the extended configuration. The first arm and the second arm can be permanently or removably attached to the first face of the container. The first arm can contain a first hole 805 at some point between the first arm first end and the first arm second end. The second arm can contain a second hole 815 at some point between the first arm first end and the second arm second end. Both the first hole and the second hole allow for an object, such as a pin, to pass through at least the first hole and the second hole. The system 700 includes a pin 810 configured to pass through at least one of the first hole and second hole configured to removably secure the container to the ladder.

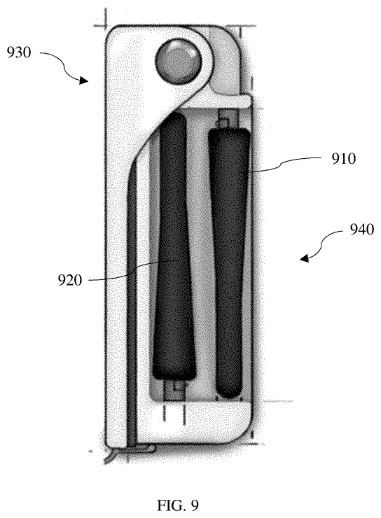

With reference to FIG. 9, a side view of the device for safekeeping of building permits and other documents is shown, according to an example embodiment. When the first arm 910 and the second arm 920 are removably attached to the first face of the container 930, assembly may be required to re-affix them to the first face when first arm and the second arm are in the storage configuration of the container. In one embodiment, the first arm and second arm are foldable, such that the first arm and the second arm are parallel to the first face in a stored configuration and perpendicular to the first face in an assembled configuration. To achieve the folded configuration, the first arm and second arm can collapse telescopically within themselves. In addition, the first arm and second arm may be constructed of several pieces or tubes which attach to one another or detach from one another to fold the arms. When the first arm and the second arm are in the extended or assembled configuration, the first arm and the second arm are perpendicular to the first face. In addition, the first arm can be attached, permanently or removably, to the first face via a fastener at the first arm first end or at the first arm second end. The second arm can be attached, permanently or removably, to the first face via a fastener at the second arm first end or at the second arm second end.

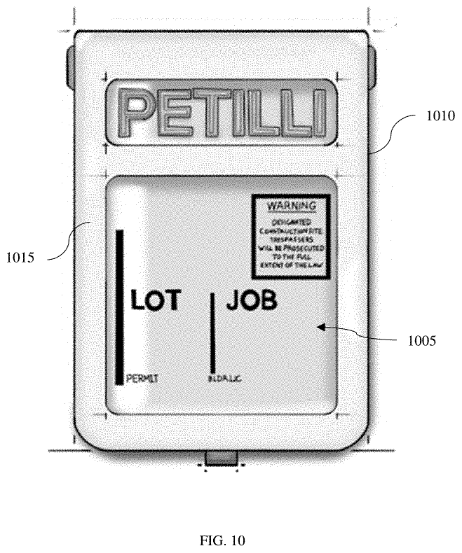

Referring to FIG. 10, the translucent window allows the user to view the contents within the container, such as building permits, documents, or other items, while the container is in the closed configuration. In one embodiment, the system 100 has a lid 1010 that has a translucent window 1005. The translucent window material may be comprised of many materials and/or combination of materials including any type of plastic and glass. When the lid is closed as illustrated in FIG. 10, the lid may define a second face 1015 of the container where the second face of the container defines a writing surface. In example embodiment, the second face may contain a flat portion such that the user may write on the surface of the container. In another example embodiment, the second face may be any face that is parallel to the stringer of the ladder such that the user can write on the surface of the container while standing on the ladder, for example, the side of the container, when the system is attached to the stringer of the ladder using the pressure grip clamps.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A device for safekeeping of building permits and other documents, wherein the device is for removably attaching to a ladder having a plurality of rungs, the device comprising:
a container;
a first arm having a first arm first end and a first arm second end;
a second arm having a second arm first end and a second arm second end; and
wherein the first arm first end and the second arm first end are each movably in attachment with a side of the container.

2. The device of claim 1, further comprising:
a stowed configuration wherein the first arm second end and second arm second end are disposed proximate to the side of the container; and
an extended configuration wherein the first arm and the second arm are each disposed substantially perpendicular to the side of the container.

3. The device of claim 2, wherein the first arm and the second arm are tapered from its respective first end to its respective second end, such that that the first end comprises a first cross section having a first diameter greater than a second diameter of a second cross section of the second end.

4. The device of claim 2, wherein the device comprises a handle.

5. The device of claim 4, wherein the handle is defined by a recessed portion on a back side of the container.

6. The device of claim 2, wherein the container comprises a lid having (i) a lid first surface that faces the inside of the container and (ii) a lid second surface that faces away from the container when the lid is in a closed position.

7. The device of claim 6, wherein the lid is hingedly attached to a bottom portion of the container.

8. The device of claim 7, wherein a clip is attached to the lid first surface proximate to the bottom portion of the container.

9. The device of claim 7, wherein the lid comprises at least one side wall proximate to the side of the container.

10. The device of claim 9, wherein, in the stowed configuration, the at least one side wall at least partially covers a portion of at least one of the first arm and the second arm.

11. The device of claim 10, wherein, in the extended configuration, the at least one side wall comprises at least one cutout configured to at least partially surround at least one the first arm and the second arm.

12. The device of claim 11, wherein, the at least one side wall defines a serpentine shaped edge such that the lid may open and close when the container is in the extended configuration.

13. The device of claim 3, wherein the second diameter is less than a rung diameter of an opening of a channel of a rung of a ladder, wherein the opening is on the stringer of the ladder.

14. A system for safekeeping of building permits and other documents, the system comprising:
a. a ladder comprising a plurality of rungs spaced apart and extending through a stringer of the ladder; wherein each rung of the plurality of rungs has a channel, wherein the channel has opening on the stringer,
b. a device comprising;
(i) a container;
(ii) a first arm having a first arm first end and a first arm second end;
(iii) a second arm having a second arm first end and a second arm second end;
(iv) wherein each of the first arm and the second arm are in attachment with a side of the container, and
c. an assembled configuration wherein the opening of a first rung of the plurality of rungs receives the first arm second end and the opening of a second rung adjacent to the first rung receives a second arm second end.

15. The system of claim 14, further comprising:
a stowed configuration wherein the first arm second end and second arm second end are disposed proximate to the side of the container, and
an extended configuration wherein the first arm and the second arm are each disposed substantially perpendicular to the side of the container.

16. The system of claim 14, wherein the device comprises a lid comprising at least one side wall proximate to a side of the container, wherein the at least one side wall at least partially covers a portion of at least one of the first arm and the second arm, in a stowed configuration.

17. The device of claim 14, wherein the device comprises a lid comprising at least one side wall proximate to a side of the container, wherein the at least one side wall comprises a serpentine shaped edge.

18. The device of claim 14, wherein the first arm and the second arm are tapered from its respective first end to its respective second end, such that that the first end comprises a first cross section having a first diameter greater than a second diameter of a second cross section of the second end.

19. A method of safekeeping a plurality of items within close proximity to a ladder, the method comprising:
inserting a first arm extending from a container into a first opening of a first channel of a first rung of the ladder, wherein the first opening is on a stringer of the ladder; and
inserting a second arm extending from the container into a second opening of a second channel of a second rung of the ladder, wherein the second opening is on the stringer of the ladder.

20. The method of claim 19, wherein each of the first arm and the second arm are in attachment with a side of the container and wherein the container comprises:
a lid comprising at least one side wall proximate to the side of the container,
wherein, in a device stowed configuration, the at least one side wall of the lid at least partially covers a portion of at least one of the first arm and the second arm;
wherein the at least one side wall of the lid comprises a serpentine edge; and
wherein the first arm and the second arm are tapered from its respective first end to its respective second end, such that that the first end comprises a first cross section having a first diameter greater than a second diameter of a second cross section of the second end.
